(19) United States
(12) Patent Application Publication
(10) Pub. No.: US 2024/0101072 A1
(43) Pub. Date: Mar. 28, 2024

(54) SYSTEMS, METHODS, AND TECHNOLOGIES FOR CLEANING AND MAINTAINING OPERABILITY OF VEHICLE SENSORS

(71) Applicant: Daimler Truck North America LLC

(72) Inventor: David ANDERSON, Christiansburg, VA (US)

(21) Appl. No.: 18/372,295

(22) Filed: Sep. 25, 2023

Related U.S. Application Data
(60) Provisional application No. 63/409,853, filed on Sep. 26, 2022.

(51) Int. Cl. B60S 1/56; B60S 1/52

(52) U.S. Cl. CPC B60S 1/56; B60S 1/52

(57) ABSTRACT

Cleaning and/or maintaining operability of sensors, e.g., mounted on vehicles, e.g., autonomously operated vehicles, and systems, methods, and technologies that support the same. The sensor cleaning system can include a first fluid source and a second fluid source, and can also include a plurality of nozzles each coupled to the first fluid source and to the second fluid source and each including an outlet directed at a subset of vehicle sensors. The system can further include a control system with a controller configured to supply a first fluid from the first fluid source to a selected nozzle, or supply a combination of the first fluid from the first fluid source and a second fluid from the second fluid source to a selected nozzle, to thereby clean a subset of sensors. Methods of manufacturing, configuring, and installing such systems are also disclosed.

### CROSS-REFERENCE TO RELATED APPLICATIONS AND PRIORITY CLAIM

This non-provisional patent application claims priority to U.S. provisional patent app. No. 63/409,853, filed on Sep. 26, 2022, and titled “SYSTEM AND METHOD FOR CLEANING VEHICLE SENSORS,” the contents of which is incorporated herein by reference in the entirety.

### TECHNICAL FIELD

The field relates to cleaning optical sensors on vehicles.

### BACKGROUND

Vehicles, including autonomous vehicles, may use different types of sensors, e.g., optical sensors, e.g., cameras or light detection and ranging (“LIDAR”) sensors, and the like, to support their operation. The sensors can be used to help operate and guide the vehicle, e.g., on a roadway. However, to operate properly, sensors often need to maintain a certain level of visibility, and thus may need occasional cleaning. Existing cleaning methods such as mechanical wipers or manual cleaning can be used to clean sensors. Other cleaning methods may use a cleaning liquid, and in some cases, a compressed air source. However, these existing cleaning methods have disadvantages. For example, mechanical wipers can degrade over time and become less effective. In addition, with autonomous vehicles, a human operator may not be present to perform manual cleaning, or may only be present at certain times, e.g., prior to departure or upon arrival. Existing cleaning systems that use only a cleaning liquid require a large amount of liquid and high pressures to clean the sensors effectively. Additionally, existing systems that employ compressed air along with the cleaning fluid require a complex control arrangement and/or multiple nozzles directed at each sensor, resulting in a costly and inefficient system. There is therefore a need for a system that is capable of more effectively, consistently and efficiently cleaning vehicle sensors to help maintain their operability.

### BRIEF DESCRIPTION OF THE DRAWINGS

The embodiments herein related to systems, methods, and technologies for cleaning and maintaining operability of sensors on vehicles are described in detail with reference to the attached figures, which illustrate non-limiting examples of the disclosed subject matter, wherein:

FIG. 1 depicts a diagram of a system for cleaning vehicle sensors, in accordance with embodiments of the present disclosure;

FIG. 2 depicts a more detailed diagram of a system for cleaning vehicle sensors associated with that shown in FIG. 1, in accordance with embodiments of the present disclosure;

FIG. 3 depicts a more detailed diagram of a system for cleaning vehicle sensors associated with that shown in FIG. 1, in accordance with embodiments of the present disclosure;

FIG. 4A depicts a nozzle suitable for use with the system shown in FIGS. 1-3, in accordance with embodiments of the present disclosure;

FIG. 4B depicts another nozzle suitable for use with the system shown in FIGS. 1-3, in accordance with embodiments of the present disclosure;

FIG. 4C depicts another nozzle suitable for use with the system shown in FIGS. 1-3, in accordance with embodiments of the present disclosure;

FIG. 5 depicts a vehicle with a sensor cleaning system, in accordance with embodiments of the present disclosure;

FIG. 6 depicts a series of operational scenarios that can occur in connection with use of the sensor cleaning systems described herein, in accordance with embodiments of the present disclosure;

FIG. 7 is a block diagram of a method for cleaning vehicle sensors, in accordance with embodiments of the present disclosure;

FIG. 8 is a block diagram of another method for cleaning vehicle sensors, in accordance with embodiments of the present disclosure; and

FIG. 9 is a block diagram of another method for cleaning vehicle sensors, in accordance with embodiments of the present disclosure.

### DETAILED DESCRIPTION

The subject matter of this disclosure is described with specificity herein to meet statutory requirements. However, the description itself is not intended to limit the scope of the invention. Rather, it is contemplated that the claimed or disclosed subject matter might also be embodied in other ways, to include different steps, different combinations of steps, different features, and/or different combinations or sub-combinations of features similar to those described herein, and in connection with other present or future technologies or solutions.

In brief, and at a high level, this disclosure describes, among other things, systems, methods, and technologies for cleaning and maintaining the operability of sensors used on vehicles and on other types of mobile platforms, e.g., drones, ships, aircraft, railway transports, industrial equipment, machinery, robots, and the like. The embodiments described herein can also be used with autonomous versions of such vehicles/mobile platforms to thereby allow for cleaning associated sensors, e.g., in instances where using manual cleaning or traditional methods of mechanical cleaning may otherwise be challenging, impractical, or less efficient.

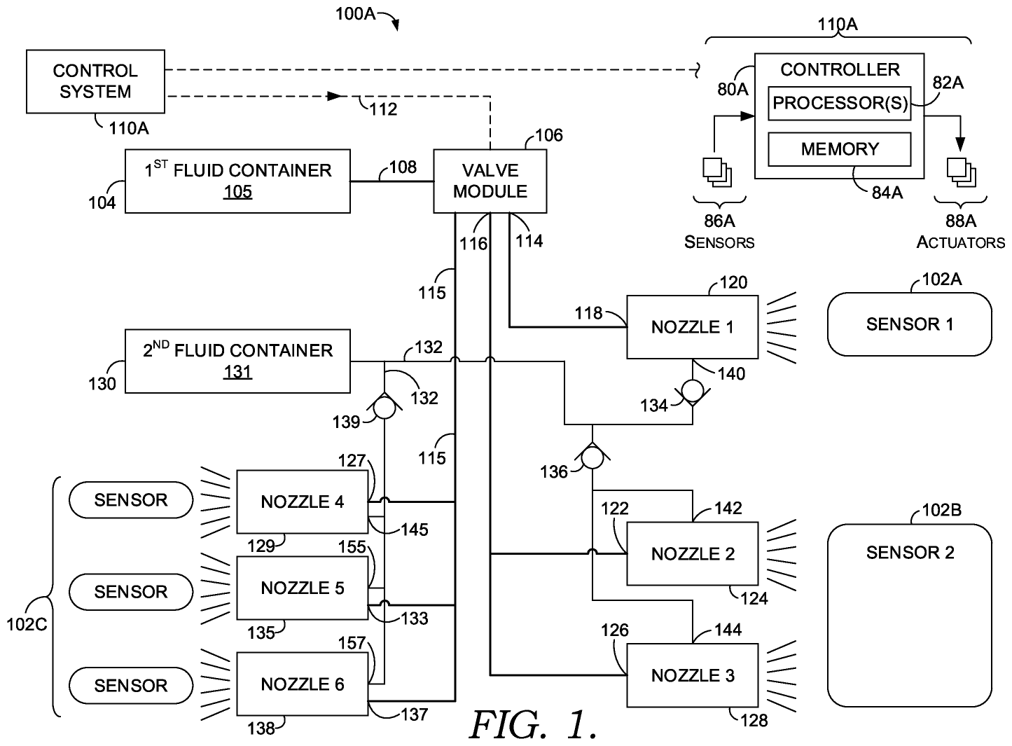

In embodiments, a sensor cleaning system is provided. The sensor cleaning system can include a first fluid container and a second fluid container. The system can include a plurality of nozzles that are each coupled to the first fluid container via a corresponding first fluid supply line and to the second fluid container via a corresponding second fluid supply line. The nozzles can each include an outlet that is directed at one or more of the sensors mounted on a vehicle. In preferred embodiments, the nozzles can each include an outlet that is directed at a single one of the sensors. In embodiments, a control system that includes a controller can be configured to direct disbursement/discharge of fluid(s) from the nozzles onto the sensors to thereby clean the sensors. For example, a controller can initiate a cleaning process by selectively supplying a first fluid to the nozzle(s), or by selectively supplying a combination of a first fluid and a second fluid to the nozzle(s). The first fluid can be compressed air. The second fluid can be liquid cleaner or cleaning solution, e.g., of a type suitable for cleaning transparent surfaces. In embodiments, the controller, in a first condition, can cause the first fluid to be discharged from the nozzle(s) to clean the sensor(s) and, in a second condition, the controller can cause the first fluid and the second fluid to be discharged from the nozzle(s) to clean the sensor(s). In doing so, the system can help maintain continued operation and performance of the sensor(s), among other benefits. In further embodiments, a vehicle, e.g., one that is human-operated or at least partially or fully autonomously operated, e.g., such that it can operate without continuous inputs from a human operator, is provided that includes at least one sensor cleaning system as described herein. In further embodiments, a method of manufacturing, modifying, and/or retrofitting a vehicle, e.g., one that is human-operated or autonomously operated, so that it includes at least one sensor cleaning system as described herein is provided. In further embodiments, a method of manufacturing a system for cleaning vehicle sensors as described herein is provided. The attached FIGS. 1-8 illustrate non-limiting embodiments and are described in detail in the following sections.

Looking now at FIG. 1, a diagram of a system 100A that can be used for cleaning and maintaining operation of vehicle sensors (e.g., such as sensors 102A, 102B, 102C) is shown, in accordance with embodiments of the present disclosure. More specifically, the system 100A can be used for cleaning and maintaining a sensor lens or window associated with the sensor. As described herein, when the any of the sensors is cleaned, it is to be understood that the sensor lens or window is being cleaned. The system 100A can be deployed on a human-operated vehicle and/or on an autonomously operated vehicle, e.g., a vehicle that can be operated without continuous input from a human operator and/or a vehicle that does not require that a human operator be locally present to operate it. The system 100A can also be used with other vehicles and mobile transports, e.g., autonomous or non-autonomous, as described herein. The sensors 102A, 102B, 102C and others described herein can be any of numerous types of sensors suitable for supporting operation of a mobile platform. For example, the depicted sensors 102A, 102B, 102C can be optical sensors, e.g., those associated with various cameras that operate inside or outside the visual spectrum, LIDAR, radar, and the like, or other types of sensors.

The system 100A includes a first fluid container 104 that is configured to hold a first fluid 105. In embodiments, the first fluid container 104 is a tank (e.g., coupled to a compressor, not shown) and the first fluid 105 is dry, compressed air. In embodiments, the first fluid container 104 can be a compressed air tank that is also used by other vehicle systems (e.g., braking systems, transmission systems, and the like). In embodiments, the first fluid container 104 can be a compressed air tank that is used separate from other vehicle systems (e.g., braking systems, transmissions systems, and the like). The first fluid container 104 is coupled, e.g., fluidically coupled or connected, to an inlet of a valve module 106. The coupling of the first fluid container 104 to the valve module 106 can be provided via flexible hoses, pipes, or other types of fluid lines or conduits (labeled 108 in FIG. 1) capable of transporting a fluid, e.g., such as compressed air. The valve module 106 is also communicatively connected to a control system 110A, e.g., through a controller area network (“CAN”), or through another wired or wireless connection, represented by line 112.

In embodiments, e.g., as shown in FIG. 1, the control system 110A can include a controller 80A. The controller 80A may include processor(s) 82A (e.g., one or more micro-processors) configured to execute instructions stored in non-transitory memory 84A to thereby initiate or control different operations and functions of the system 100A. In embodiments, sensors 86A can be positioned throughout the system 100A and used to provide sensor feedback to the controller 80A as shown in FIG. 1. The controller 80A can use the sensor feedback in conjunction with other instructions stored in the memory 84A to control operation of actuators 88A. The actuators 88A can be distributed throughout the system 110A and configured to operate/control different parts of the system 100A. For example, the actuators 88A can be used to control the position of valves (e.g., open, closed, or adjusted to use a particular fluid pathway) such as those included in the valve module 106 shown in FIG. 1. The actuators 88A are intended to represent many possible types of actuating components including those that are mechanical, electrical, hydraulic, and/or pneumatic in their operation. For example, in embodiments, the actuators 88A can be linear actuators, rotary actuators, motors, switches, solenoids, pumps, compressors, or other similar devices.

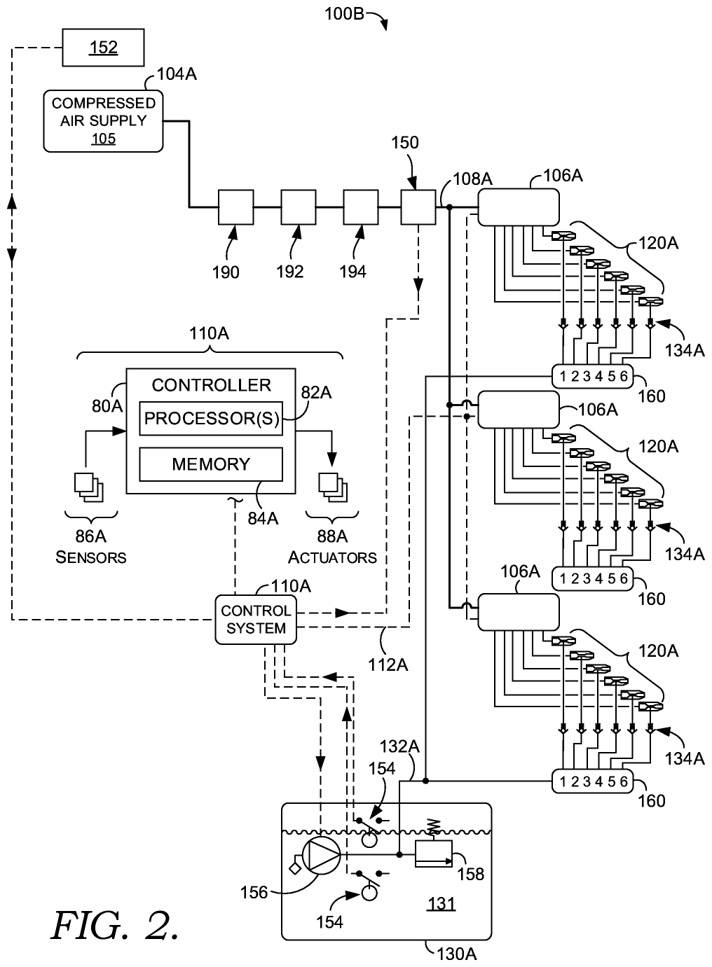

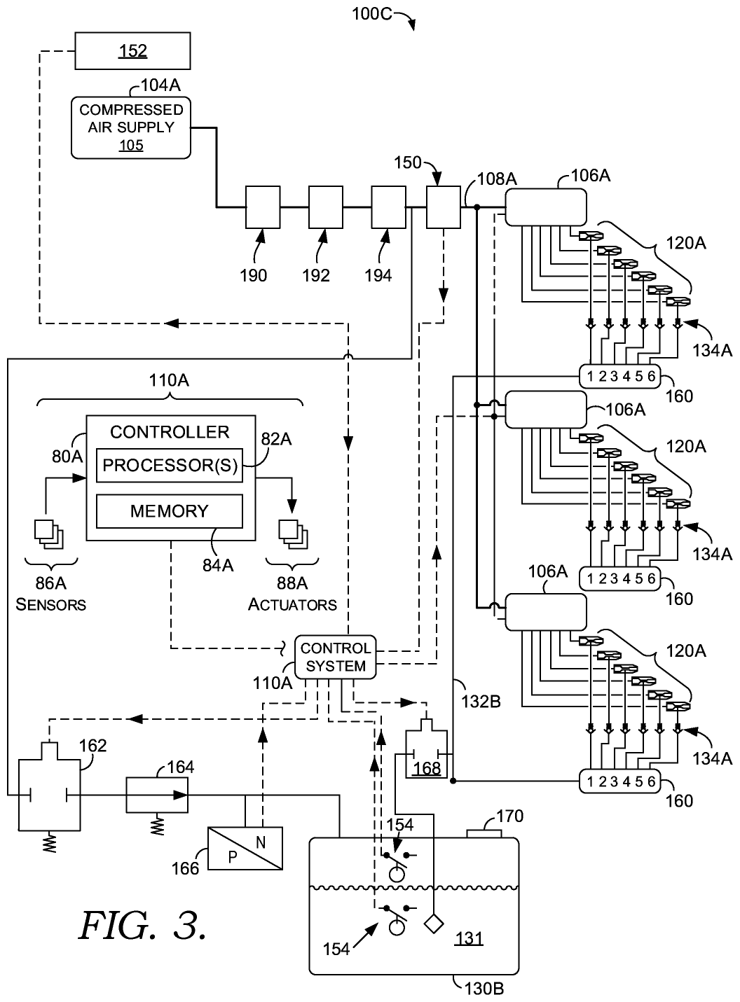

In FIG. 1, the valve module 106 includes a plurality of fluid outlets that are represented in FIG. 1 by lines 114, 115, 116. For clarity, the lines 108, 114, 115 and 116, carrying the first fluid 105, are shown with a greater width. Three outlets are shown on the valve module 106 in FIG. 1. However, in additional or alternative embodiments, the valve module 106 may include a greater number of outlets, e.g., as described in connection with the embodiments of FIGS. 2 and 3, that correspond to a greater number of nozzles that can be operated/cleaned. The fluid line 114 is coupled to an inlet 118 of a nozzle 120. The fluid line 116 is coupled to an inlet 122 of a nozzle 124 and to an inlet 126 of a nozzle 128. The fluid line 115 is coupled to an inlet 127 of a nozzle 129, to an inlet 133 of a nozzle 135, and to an inlet 137 of a nozzle 138. The control system 110A communicates with the valve module 106 to selectively allow the first fluid 105 in the first fluid container 104 to be routed to the nozzle 120, and/or to the nozzles 124 and 128, and/or to the nozzles 129, 135 and 138.

The system 100A includes a second fluid container 130 that contains a second fluid 131. In embodiments, e.g., as discussed below in connection with FIGS. 2 and 3, the second fluid 131 can be a liquid, e.g., a cleaning fluid or cleaning solution, e.g., of the type suitable for cleaning transparent materials, e.g., that form sensor covers. In embodiments, the second fluid may include an antifreeze agent, an antibacterial and/or other additive. In embodiments, the second fluid container 130 may be sized (volumetrically) to contain enough liquid cleaner to allow at least one trip of the vehicle. In other embodiments, the second fluid container 130 may be sized (volumetrically) to contain enough liquid cleaner for between about 7-90 days of vehicle use, and in some embodiments for about two weeks of vehicle use. In FIG. 1, the second fluid container 130 includes an outlet line 132 that is coupled to the nozzle 120 via a valve 134 (e.g., a check-valve), to the nozzles 124, 128 via a valve 136 (e.g., a check-valve), and to the nozzles 129, 135, 138 via a valve 139 (e.g., a check-valve). More specifically, the valve 134 controls the flow of fluid from the line 132 into an inlet 140 of the nozzle 120. Similarly, the valve 136 controls the flow of fluid from the line 132 into an inlet 142 of the nozzle 124 and into an inlet 144 of the nozzle 128. Similarly, the valve 139 controls the flow of fluid from the line 132 into an inlet 145 of the nozzle 129, into an inlet 155 of the nozzle 135, and into an inlet 157 of the nozzle 138.

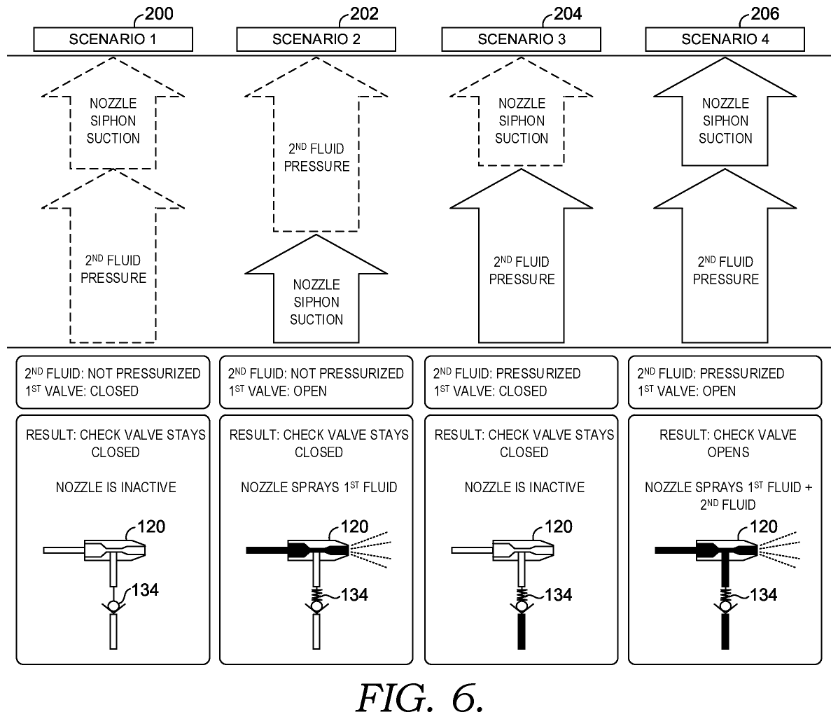

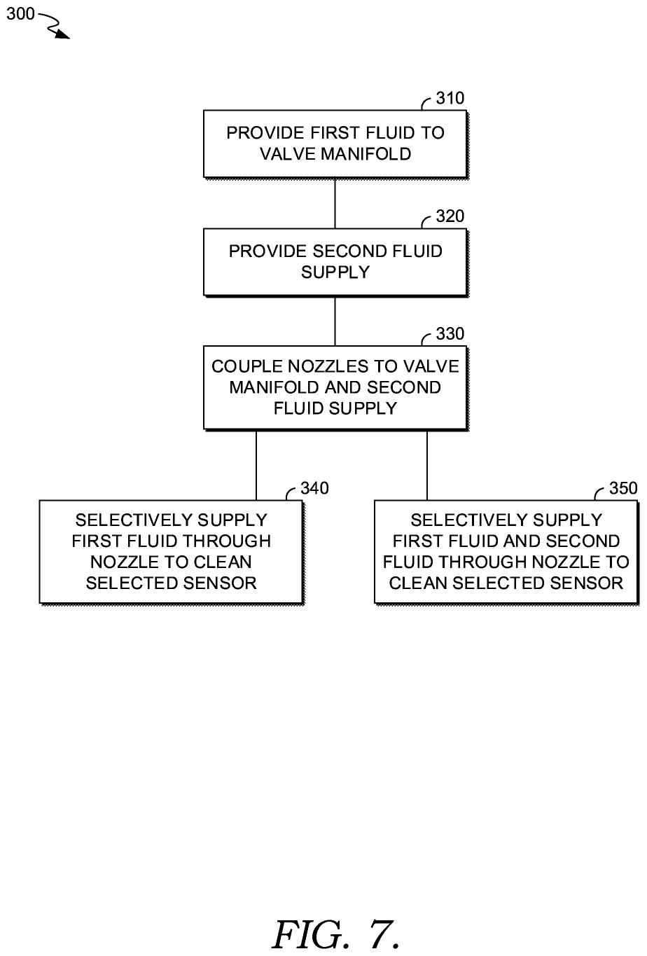

In operation, the system 100A can selectively supply the first fluid 105 to any of the nozzle 120, the nozzles 124, 128, and/or the nozzles 129, 135, 138, and by association onto the sensor 102A (through the nozzle 120), onto the sensor 102B (through the nozzle 124 and nozzle 128), and/or onto the sensors 102C (through nozzles 129, 135, 138). In embodiments, the first fluid 105 can be dry compressed gas (e.g., dry compressed air), and can be used to dry or clear liquid (such as rain, or liquid cleaner for example) from the sensors 102A, 102B, 102C. The system 100A can also selectively supply the second fluid 131 from the second fluid container 130 to the outlet line 132 by pressurizing the second fluid 131 in the second fluid container 130 (as discussed further below with respect to FIGS. 2 and 3). The pressurized second fluid 131 can then be moved to the valve 134, to the valve 136, and to the valve 139. The second fluid 131, being pressurized, can move through the valve 134 when the first fluid 105 is routed through the nozzle 120 due to a siphon caused by the first fluid 105 as it passes through the nozzle 120 (as discussed further below with respect to FIGS. 6 and 7). The combined flow of the first fluid 105 and the second fluid 131 can then be delivered by the nozzle 120 onto the sensor 102A. Similarly, the second fluid 131, being pressurized, can move through the valve 136 when the first fluid 105 travels through the nozzle 124 and through the nozzle 128 due to a siphon caused by the first fluid 105 as it travels/passes through the nozzles 124, 128. The combined flow of the first fluid 105 and the second fluid 131 can then be delivered by the nozzle 124 and the nozzle 128 onto the sensor 102B. Similarly, the second fluid 131, being pressurized, can then move through the valve 139 when the first fluid 105 is moved through the nozzles 129, 135, 138 due to a siphon caused by the first fluid 105 as it travels/passes through the nozzles 129, 135 and 138. The combined flow of the first fluid 105 and the second fluid 131 can then be delivered through the nozzles 129, 135, 138 onto the sensors 102C. The system 100A thus allows the sensor lens or sensor window of the sensors 102A, 102B, 102C to be selectively cleaned, e.g., without manual intervention, using either the first fluid 105, or using a combination of the first fluid 105 and the second fluid 131 depending on a type of cleaning that is desired or suitable. In addition, the ability to optionally use just compressed air for cleaning sensors allows for such cleaning to be performed with a continuously replenished resource (e.g., the compressed air). In other words, the cleaning solution, a consumable resource that can only be refilled at intermittent opportunities, can be selectively used when a soiling blockage is impeding proper operation of the target sensor. This helps limit the need to replenish the cleaning solution, and thereby allows for a longer use of the system. More importantly, because many cleaning solutions require harmful additives, reduction of their use lessens harmful environmental impacts. Moreover, the system 100A also provides selective use of the cleaning solution with the compressed air, which effectively cleans the sensors utilizing less cleaning solution (as compared to a system using only liquid cleaning solution). The system 100A may have one nozzle per sensor (e.g., as with nozzle 120 and sensor 102A), two or more nozzles per sensor (e.g., as with nozzles 124, 128 and sensor 102B), or multiple nozzles for multiple sensors that use the same fluid circuit (e.g., as with nozzles 129, 135, 138, and the sensors 102C), or a combination of the same.

Looking now at FIG. 2, another diagram of a system 100B for cleaning sensors, e.g., mounted on a vehicle, is provided, in accordance with embodiments of the present disclosure. The system 100B includes some overlapping components with the system 100A shown in FIG. 1. In addition, many elements shown in FIG. 2 can form part of existing systems integrated into a vehicle. For example, the first fluid container 104A can be an existing compressed air supply integrated into an associated vehicle. Other components of the system 100B could be supplied as a kit, to be installed on a vehicle and integrated into the existing control system of the vehicle. In embodiments, the first fluid container 104A could be a compressed air supply separate from other systems on the vehicle. The first fluid 105 stored in the first fluid container 104A can thus be dry compressed air. In embodiments, the system 100B can be configured so that this compressed air can be supplied at a pressure that is between about 80-120 PSI (or between about 551-827 Kilopascals (“kPa”) or between about 5.5-8.3 bar), or supplied at a pressure of at least about 90 PSI (or at least about 620 kPa).

Looking at the configuration shown in FIG. 2, the first fluid 105 can follow a particular path when communicated through the system 100B. In particular, the first fluid 105 can be routed first through a shut-off valve 190, then routed through a pressure regulator 192, and then routed through an over-pressure valve 194 before reaching the valve module 106A. The shut-off valve 190 can be configured to close if the flowrate (e.g., volumetric flow rate) of the first fluid 105 through the valve 190 exceeds a selected threshold, e.g., a threshold at which desired performance parameters of downstream components become exceeded. This limits the possibility of airline degradation/leaking, and in addition, can allow for isolating fluid degradation that occurs within the system 100B. The pressure regulator 192 can be configured to operate as a fixed-pressure regulator and as a result can reduce the pressure of the first fluid 105 to a pressure desired for use downstream in the system 100B. In embodiments, the pressure regulator 192 can be configured to control the pressure of the first fluid 105 to a pressure level that is between about 80-120 PSI (or between about 551-827 Kilopascals (“kPa”) or between about 5.5-8.3 bar), or so that it is supplied at a pressure of at least about 90 PSI (or about 620 kPa). However, in embodiments, other pressures and/or other ranges of pressures can be used in the systems described herein.

In embodiments, the over-pressure valve 194 can be a valve designed to limit the maximum pressure the system 100B experiences if the pressure regulator 192 were to stop controlling the pressure as intended. In embodiments, the over-pressure valve 194 can be set to a value of about 10 PSI (or about 6.9 kPa) higher than the pressure regulator 192 (so, for example, if the pressure regulator is set to 90 PSI, the over-pressure valve 196 may be set to 100 PSI). If this pressure is exceeded, the valve 194 opens to the external atmosphere. Or, in embodiments, the over-pressure valve 194 may be set to a pressure that is between about 2-20% higher than the pressure controlled by the pressure regulator 192. The system 100B may also include a pressure sensor 150 located at the outlet line of the over-pressure valve 194. The pressure sensor 150 can be used to monitor the pressure in the first fluid line 108A and send that information to the control system 110A. The control system 110A can control different parts of the system 100B similar to what is described in connection with FIG. 1. As with the system 100A in FIG. 1, the control system 110A includes the controller 80A with the processor(s) 82A and memory 84A thereof that obtains feedback from the sensors 86A and that can operate the actuators 88A to control different parts of the system 100B, e.g., based on instructions associated with different conditions of operation. The pressure sensor 150 can form part of the sensors 86A.

FIG. 2 shows how the system 100B can include a number of valve modules 106A each configured to receive the first fluid 105. Three valve modules 106A are shown in FIG. 2, but in other embodiments, the system 100B can include any number of such valve modules 106A suitable for a number and configuration of nozzles and sensors to be cleaned. Each valve module 106A includes a plurality of valve outlets. FIG. 2 depicts six valve outlets for each valve module 106A. However, in embodiments, the valve modules 106A can include more, or fewer, valve outlets than those depicted in FIG. 2. Each valve module 106A controls flow individually though each valve outlet and to the inlet of each nozzle (for simplicity, the nozzles in FIG. 2 are collectively labeled 120A). While not shown in FIG. 2, each nozzle 120A includes an outlet that can be directed at one or more vehicle sensors, e.g., as discussed in connection with FIG. 1. As discussed above with respect to FIG. 1, each nozzle can be directed at a single sensor, or multiple nozzles can be directed at a single sensor, or multiple nozzles can be directed at multiple sensors, e.g., arranged as an integrated array. In embodiments, each nozzle may be pointed directly at a sensor, e.g., along an axis thereof, or at an angle to the sensor, e.g., at an angle to an axis thereof, or multiple nozzles may point at a sensor from multiple angles to increase the disbursement onto the sensor. In FIG. 2, each valve module 106A is communicatively connected to the control system 110A (i.e., as indicated by communication line 112A), which is configured to command the valve module 106A, e.g., through operation of actuators 88A and/or valves 134A, to control the flow of the first fluid 105 through the valve module 106A and subsequently to the nozzles 120A. The control system 110A associated with sensor cleaning may also be connected to a main controller 152. The main controller 152 may be similar in nature to the control system 110A, but may instead be associated with a broader vehicle control system. For example, in embodiments, the main controller 152 may provide instructions, information, or control signals to the control system 110A for coordinated operation with other vehicle systems, e.g., powertrain, navigation, and/or steering control.

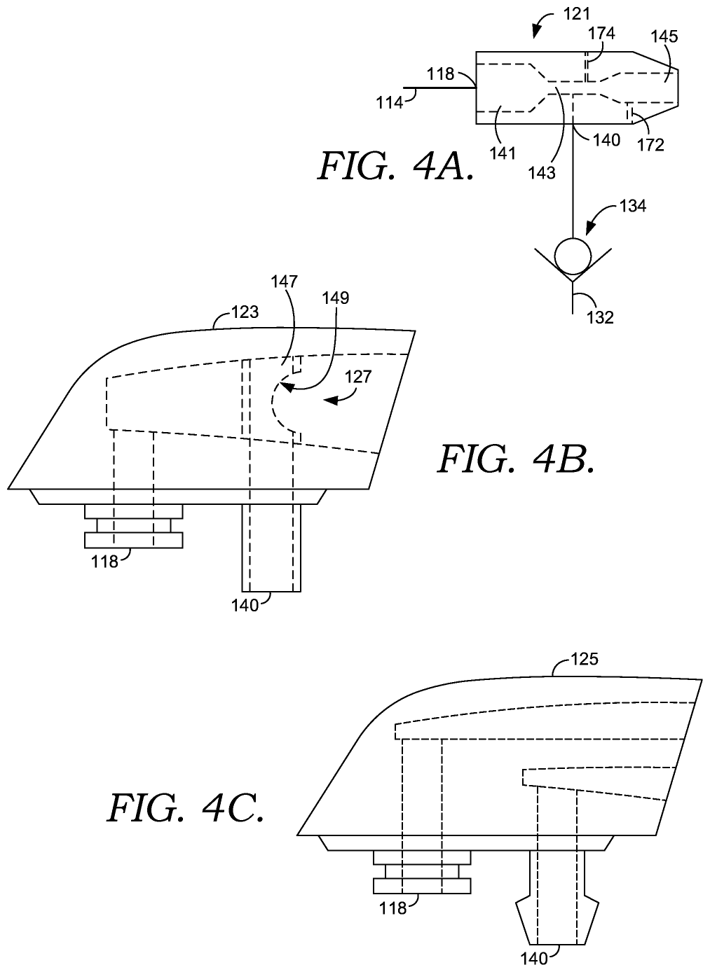

FIG. 2 also depicts the second fluid container 130A containing the second fluid 131. In embodiments, the second fluid container 130A can include at least one fluid level sensor 154 that is configured to send signals to the control system 110A. For example, the signals can indicate if the second fluid 131 is above or below a threshold (e.g., minimum desired) fluid level for the second fluid container 130A. The second fluid 131 may be pressurized in the outlet line 132A by a pump 156, the operation of which can be controlled by the control system 110A. In embodiments, the pressure within the outlet line 132A can also be controlled or regulated by a pressure control valve 158. In embodiments, the pressure within the outline line 132A can be about 5 PSI (or about 35 kPa). When the pump 156 is operated to pressurize the second fluid 131 (e.g., a liquid cleaner or cleaning solution), the second fluid 131 then moves through the outlet line 132A and to a manifold 160 before reaching a valve (for simplicity's sake, each valve is labeled 134A in FIG. 2; each valve 134A may be a check-valve). Each valve 134A is configured to inhibit the second fluid 131 from entering a corresponding nozzle 120A, unless the first fluid 105 is also being moved through the corresponding nozzle 120A. In other words, each valve 134A is calibrated to allow the second fluid 131 to enter the corresponding nozzle 120A if the first fluid 105 is communicated through the corresponding nozzle 120A. In embodiments, as the first fluid 105 passes through the nozzle 120A, a pressure drop, or siphon, is created at a secondary inlet (labeled 140 in FIG. 4) of the nozzle 120A, and this siphon overcomes and opens the valve 134A and allows for a combined discharge from the nozzle 120A of the first fluid 105 and the second fluid 131. The valve 134A is selected based on the pressure of the first fluid 105 and the pressure of the second fluid 131 in the outlet line 132, such that the valve 134 allows the second fluid 131 to flow into the nozzle 120A when the first fluid 105 passes through the nozzle. FIG. 2 does not show the sensors located adjacent to the outlet of the nozzles 120A, but each nozzle 120A can be associated with a subset of sensors (e.g., one or more sensors) that are cleaned by discharge from the nozzles 120A. The system 100B thus utilizes many controls (through the valve modules 106A, and the actuators 88A) to selectively dispense the first fluid 105 onto the sensors, but needs only to control the pressure in the outlet line 132 to selectively dispense a combination of the first fluid 105 and the second fluid 131 onto the sensors. Due to the siphon at the nozzle 120A, the system 100B is of a more-efficient design as opposed to having to independently control the flow of the second fluid 131 (such as with a control for the second fluid 131 for each nozzle and sensor). Such a system not only offers cost-savings and space savings, but also allows for effective cleaning of the sensor lenses or sensor windows using less cleaning liquid (second fluid 131) by using the first fluid as an accelerant. The system therefore uses more of a fluid source (air) that is easily replenished (e.g., by an air compressor) and less of a fluid that is less easily replenished (e.g., refilling a liquid tank), such as the cleaning liquid. Additionally, by requiring less of the second fluid, the tank size for the second fluid can be smaller which reduces the size and weight requirements of the system.

Looking now at FIG. 3, a diagram of a system 100C configured for cleaning sensors, e.g., mounted on a vehicle, is shown, in accordance with embodiments of the present disclosure. The system 100C is similar to the systems 100A and 100B shown in FIGS. 1 and 2, except that it differs with respect to how the second fluid container 130B is configured and integrated into the system 100C. The components shown in FIG. 3 that are also shown in FIGS. 1 and 2 are not described again, but are labeled consistently with the corresponding components shown in FIGS. 1 and 2. The system 100C shown in FIG. 3 is configured to use compressed air from the first fluid container 104A to pressurize the second fluid container 130B. To control this distribution of compressed air, the system 100C can include, in embodiments, a solenoid valve 162 that is electronically coupled to the control system 110A such that it can be operated by the controller 80A. The solenoid valve 162 can be maintained in a closed position to inhibit the pressure in the second fluid container 130B from creeping, e.g., increasing, in a way that is undesired. In FIG. 3, the system 100C also includes a pressure-reducing valve 164. The pressure-reducing valve 164 can be used to control/set the pressure within the second fluid container 130B and pressurize the outlet line 132B to move the second fluid 131 to the valves 134A (e.g., that can be check valves). In embodiments, the system 100C may also include a pressure sensor 166 that monitors the pressure of the second fluid container 130B (and may communicate the sensed pressure back to the control system 110A). The pressure sensor 166 can thus form part of the sensors 86A that send signals to the controller 80A that can then use the signals at least in part to control operation of the actuators 88A attached to components of the system 100C.

The outlet line 132B includes a solenoid valve 168 that is electrically coupled to, and controlled by, the control system 110A. The solenoid valve 168 is normally closed, and is controlled (by a signal from the control system 110A) to an open position (e.g., through actuation of the solenoid) when the second fluid 131 is to be discharged. To state it differently, in a first condition, the solenoid valve 168 is closed, and in a second condition, the solenoid valve 168 is open (e.g., a condition where electrical current is supplied to the solenoid valve 168) thereby allowing the second fluid 131 to be supplied to the outlet line 132B. The second fluid 131, with the solenoid valve 168 powered and thus open, is thus supplied through the outlet line 132B to each of the valves 134A. In embodiments, the second fluid container 130B may include a fill cap 170 that may incorporate an over-pressure release valve, set to the operating pressure of the second fluid container 130B, with a margin (e.g., in addition of about 1-10% in embodiments). In addition, in the system 100C, the second fluid container 130B can be sized to allow an air space above the second fluid 131 to buffer the air pressure.

Looking still at FIG. 3, and the system 100C, when the second fluid container 130B is pressurized and the solenoid valve 168 is powered and thus open, the second fluid 131 (e.g., a liquid cleaner or cleaning solution) is then communicated through the outlet line 132B and to the manifold 160A before reaching a valve (for simplicity's sake, each valve is labeled 134A in FIG. 3; each valve 134A can be a check-valve). Each valve 134A inhibits the second fluid 131 from entering a corresponding nozzle 120A, unless the first fluid 105 is also being communicated through the corresponding nozzle 120A. In other words, the valve 134A (e.g., check valve) is calibrated to allow the second fluid 131 to enter the corresponding nozzle 120A if the first fluid 105 is traveling through the corresponding nozzle 120A changing the pressure therein. In embodiments, as the first fluid 105 is communicated through the nozzle 120A, a siphon is created at the secondary inlet (e.g., 140 in FIG. 4A) of the nozzle 120A. This siphon can overcome/open the valve 134A, thus producing a combined discharge from the nozzle 120A of the first fluid 105 and the second fluid 131. FIG. 3 does not show sensors adjacent to the outlets of the nozzles 120A, but each nozzle 120A can be associated with a subset of sensors, e.g., as discussed in connection with FIG. 1, such that discharge from the nozzles 120A cleans the adjacent sensors.

Looking now at FIGS. 4A-4C, a selection of different nozzles 121, 123, 125 that can be used as a nozzle configuration for any of the nozzles 120, 124, 128, 129, 135 and/or 138 for cleaning and/or maintaining operability of sensors, e.g., in connection with the systems 100A, 100B, 100C shown in FIGS. 1-3, any combination thereof, or other systems, are provided, in accordance with embodiments of the present disclosure. FIGS. 4A-4C represent example configurations of nozzles discussed herein. However, many others are contemplated as within the scope of this disclosure. In addition, FIGS. 2 and 3 discuss the operation of nozzles configured generally as shown in FIG. 4A, but it should be understood that the nozzles shown in FIG. 4B or FIG. 4C could instead be used, and that different combinations of nozzle construction could be used within any of the systems 100A, 100B, 100C described in connection with FIGS. 1-3.

Any of the above described nozzles can, in embodiments, have a construction shown as nozzle 121 in FIG. 4A. The nozzle 121 includes a first inlet (e.g. a primary inlet)(such as inlet 118 for nozzle 120 in FIG. 1) that is coupled to the first fluid line (such as the fluid line 114 in FIG. 1). The nozzle 121 also includes a second inlet (such as inlet 140 for nozzle 120 shown in FIG. 1) (e.g., a secondary inlet) that is coupled to the second fluid outlet line 132 via the valve 134. The nozzle 121 is constructed to utilize the Venturi effect, where the flow of the first fluid 105 enters in a high-pressure chamber 141. The fluid increases in velocity in a central, constricted area 143 adjacent the inlet 140. The increased velocity of the first fluid 105 draws a vacuum on the inlet 140. If the second fluid outlet line 132 is pressurized, the siphon (or vacuum) overcomes the check valve 134, allowing both the first fluid 105 and the second fluid 131 to flow through the nozzle 121, into an outlet chamber 145, and onto a corresponding sensor. In embodiments, the nozzle 121 may also include a drain port 172 that allows fluid remaining in the nozzle 121, e.g., after reducing flow to the nozzle 121, to drain out of the nozzle 121. Further, in embodiments, the nozzle 121 may be equipped with a heating element 174 that can be operated to inhibit the freezing of any extraneous fluid (such as from rain, snow or sleet, or in low-ambient temperature conditions) inside the nozzle 120. FIG. 4B depicts another nozzle 123. Again, any of the above described nozzles can, in embodiments, have a construction shown as nozzle 123 in FIG. 4B. The nozzle 123 includes a first inlet (e.g. a primary inlet)(such as inlet 118 for nozzle 120 in FIG. 1) that is coupled to the first fluid line (such as the fluid line 114 in FIG. 1). The nozzle 123 also includes a second inlet (such as inlet 140 for nozzle 120 shown in FIG. 1) (e.g., a secondary inlet) that is coupled to the second fluid outlet line 132 via the valve 134, as described above. The first fluid enters the nozzle 123 at the inlet 118 under high pressure and passes around a discharge tube 147 in the internal cavity of the nozzle 123. The discharge tube is in communication with the second inlet, and also has an outlet 149 within the internal cavity of the nozzle 123. If the second fluid outlet line 132 is pressurized, the siphon (or vacuum) drawn on inlet 140 overcomes the check valve 134, allowing both the first fluid 105 and the second fluid 131 to flow through the nozzle 123, into an outlet chamber 127, and onto a corresponding sensor. While not shown in FIG. 4B, in embodiments, the nozzle 123 of FIG. 4B may also include the drain port 172 and the heating element 174 discussed in connection with FIG. 4A. FIG. 4C depicts another nozzle 125 that includes the (e.g., primary) inlet 118 that is coupled to the first fluid line 108. The nozzle 125 also includes the (e.g., secondary) inlet 140 that is coupled to the second fluid outlet line 132. The nozzle 125 is configured so that the second fluid can be directly injected into the nozzle 125 through the inlet 140 rather than being introduced through the siphon described in connection with FIG. 4A. While the nozzle 125 of FIG. 4C requires more control infrastructure (in that the delivery of the second fluid 131 to each nozzle would be individually controlled as compared to the nozzle of FIG. 4A or FIG. 4B), the nozzle 125 of FIG. 4C would still require less cleaning fluid, due to the use of the first fluid as an accelerant for the cleaning solution. Specifically, it is herein recognized that the high pressure air acts as an accelerant for the liquid in the embodiments disclosed. In the absence of the accelerant, cleaning effectiveness may be reduced, hence much more liquid cleaning solution would be required to achieve a similar level of cleaning that could otherwise be achieved by a system that uses a liquid and also includes an accelerant. In embodiments, the nozzle 125 can include the drain port 172 and the heating element 174 discussed in connection with FIG. 4A.

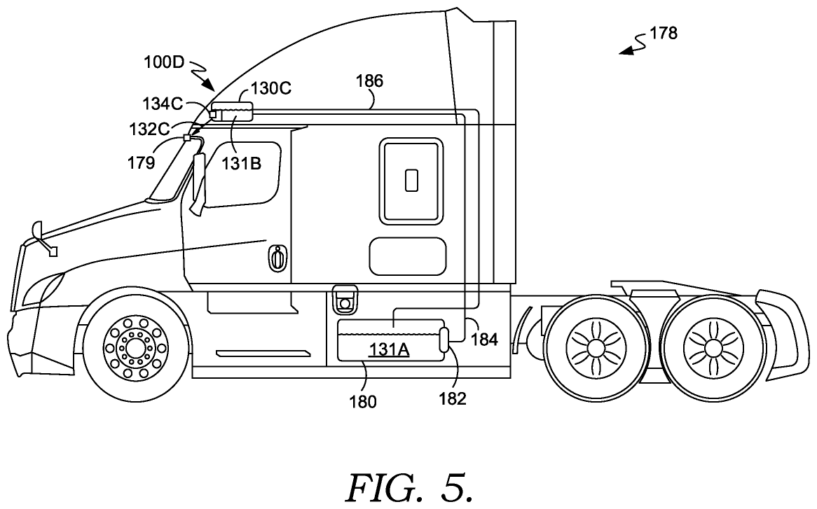

Looking now at FIG. 5, a vehicle 178 with a system 100D that allows for cleaning and/or maintaining the operation of sensors, e.g., such as forward-facing sensor/sensor array 179, thereon is shown, in accordance with embodiments of the present disclosure. The array 179 is merely one example, and it should be understood that the sensors described herein, in embodiments, offer a complete view around the vehicle. The system 100D can incorporate any of the components and configurations shown and described in connection with the systems 100A, 100B, 100C of FIGS. 1-3 and, in particular, incorporate these downstream of outlet line 132C shown in FIG. 5. For clarity, simplicity, and explanation purposes, many of the components that can be integrated downstream of the outlet line 132C, e.g., nozzles, valves, and the like, are not shown in FIG. 5, e.g., due to being integrated into the vehicle 178 and/or otherwise obscured.

The system 100D is configured to allow for efficient storage and transfer of the second fluid 131 used for sensor cleaning. With the system 100D shown in FIG. 5, the storage and supply of the second fluid 131 is separated between a larger tank 180, where the second fluid is labeled 131A, and a smaller fluid container 130C, where the second fluid is labeled 131B. The larger tank 180 allows a larger volume of the second fluid 131A to be stored in an area with more space and/or structural support. It also helps maintain a lower center of gravity of the vehicle 178 through positioning the weight of the stored fluid near the chassis, and allows for a more convenient location to refill the second fluid 131. In embodiments, and as shown in FIG. 5, the tank 180 can be located behind and/or adjacent and/or below a traditional cabin area and/or chassis area of the vehicle 178. In embodiments, the tank 180 can be configured to store between about 5-250 liters, or about 100-200 liters, and preferably about 150 liters of the second fluid 131A as identified in FIG. 5. The system 100D includes a pump 182 (e.g., an electric lift pump). Using the pump 182, the second fluid 131A can be transported from the tank 180, through a connected supply line 184, and to the fluid container 130C. The supply line 184 from the tank 180 to the fluid container 130C can follow a number of possible paths and need only accommodate the space constraints and capabilities of the pump 182 in lifting the second fluid 131A to the fluid container 130C.

In FIG. 5, it can be seen that the fluid container 130C stores a smaller volume of the fluid 131 than the tank 180. This smaller volume can be selected to accommodate a certain number of cycles of sensor cleaning with the system 100D, e.g., 10-100 cycles, or another number, in embodiments. In embodiments, the fluid container 130C may be configured to store up to about 5 liters (e.g., about 500 mL to about 1 L, or about 1 L to about 1.5 L, or about 1.5 L to about 2 L, or about 2 L to about 2.5 L, or about 2.5 L to about 3 L, or about 3 L to about 3.5 L, or about 3.5 L to about 4 L, or about 4 L to about 4.5 L, or about 4.5 L to about 5 L) of the second fluid 131B. The storing of cleaning fluid/solution in the fluid container 130C can also help reduce the distance the cleaning fluid/solution is required to travel to reach the associated nozzles where the cleaning fluid/solution is discharged. It also allows for a greater number of mounting options and locations for the fluid container 130C due to the more limited space that is needed for its mounting/enclosure. The system 100D shown in FIG. 5 also includes a return line 186 that connects the fluid container 130C and the tank 180. The return line 186 can provide a path for excess amounts of the second fluid 131B sent to the fluid container 130C, allowing it to return to the tank 180 for continued storage. In embodiments, the return line 186 can reduce or eliminate the need for precise control of the pump 182 (e.g., by control system 110A, 110B, 110C) to limit over-filling/over-pressurizing. The return line 186 can also help or ensure that the fluid container 130C remains at atmospheric pressure rather than at another undesired pressure. The return line 186 can be sized to ensure that it has more volumetric flow capacity than can be supplied by the pump 182.

The fluid container 130C is configured to supply the second fluid 131B to the outlet line 132C which can then distribute the second fluid 131B from that point on generally as described in connection with FIGS. 1-4 herein. In embodiments, the fluid container 130C can include a solenoid 134C that can be operated, e.g., by a control system as described herein, to selectively allow the flow of the second fluid 131B (such as by gravity) from the outlet line 132C to downstream nozzles that discharge the second fluid 131B onto sensors for cleaning. If the solenoid 134C is open, the second fluid 131 B enters the outlet line 132C, and the siphon generated at the nozzles can pull the second fluid 131B through the nozzles if the first fluid 105 is flowing. If the solenoid 134C is closed, the second fluid 131B is inhibited/restricted from flowing into the outlet line 132C and to the nozzles.

Looking now at FIG. 6, different possible operational scenarios 200, 202, 204, 206 that can be performed in connection with the sensor cleaning systems 100A, 100B, 100C, 100D described herein are shown, in accordance with embodiments of the present disclosure. As shown in FIG. 6, in scenario 1 (labeled 200), a valve (e.g., associated with the valve module 106) is closed to the first fluid line 108, and the second fluid container 130 is not pressurized. In this scenario 200, the associated nozzle 120 is inactive (e.g., providing no discharge/disbursement to an adjacent sensor 102). As shown in FIG. 6, in scenario 2 (labeled 202), the valve (e.g., associated with valve module 106) is open to the first fluid line 108, and the second fluid container 130 is not pressurized. In this scenario 202, the associated nozzle 120 discharges the first fluid 105 (e.g., compressed air), but not the second fluid 131 onto an adjacent sensor 102. Therefore, in scenario 202, the nozzle 120 may discharge only compressed air, which may be desirable to clear rain, liquid cleaner or cleaning solution, other liquids, or dust/particles from the sensor 102. As shown in FIG. 6, in scenario 3 (labeled 204), the valve (e.g., associated with the valve module 106) is closed to the first fluid line 108, and the second fluid container 130 is pressurized. With the second fluid 131 pressurized and communicated up to the check valve 134, but without the first fluid 105 passing through nozzle 120, no siphon is created at the secondary inlet 140 of the nozzle 120, and so the check valve 134 prevents the flow of the second fluid 131 through the nozzle 120. Therefore, in this scenario 204, the associated nozzle 120 is inactive (e.g., with no discharge/disbursement to an adjacent sensor 102). As shown in FIG. 6, in scenario 4 (labeled 206), the valve (e.g., associated with the valve module 106) is open to the first fluid line 108, and the second fluid container 130 is pressurized. With the second fluid 131 pressurized and moved up to the check valve 134, and with the first fluid 105 passing through the nozzle 120, the siphon is created at the inlet 140 of the nozzle 120, and the valve 134 spring-force is overcome (e.g., in a case where valve 134 includes a spring biasing the valve to a closed configuration), allowing the flow of the second fluid 131 through the nozzle 120 to occur. Briefly, it is to be understood that the second fluid 131 may be pressurized to above a threshold pressure, where pressures above the threshold pressure are sufficient, when combined with the siphon created at the inlet (e.g., inlet 140) but not in absence of said siphon, to overcome the spring force of the corresponding valve (e.g., valve 134), thereby delivering a combination of the first and second fluids to the sensor lens/window. Thus, in this scenario 206, the associated nozzle 120 is active, discharging/disbursing a combination of the first fluid 105 and the second fluid 131 onto an adjacent sensor 102. In an embodiment, the first fluid 105 is compressed air and the second fluid 131 is a liquid cleaner or cleaning solution (e.g. one similar to that used in connection with windshield cleaning). Therefore, in scenario 206, the system 100 discharges a combination of compressed air and liquid cleaner or cleaning solution onto an adjacent sensor, which may be triggered when the associated lens or window of the sensor 102 is dirty or soiled (rather than just wet). In embodiments, the sensor cleaning may be initiated or repeated based on determined lack of visibility through the sensor, based on signal feedback from the sensor, determined sensor inoperability, and the like, e.g., through processing by a control system as described herein. The sensor cleaning can also be performed based on a set or established schedule (e.g., every 1-4 hours of operation, or every day, or at some other regular and/or scheduled series of intervals).

Looking now at FIG. 7, a block diagram of a method 300 for cleaning and/or maintaining the functioning of vehicle sensors is shown, in accordance with embodiments of the present disclosure. In FIG. 7, the method 300 includes blocks 310-350 but is not limited to this selection of elements or the order depicted. In block 310, the method 300 includes providing a first pressurized fluid to a valve manifold, e.g., the valve manifold 160 shown in FIG. 1. In embodiments, the first pressurized fluid could be compressed air provided to an electronic valve manifold. In block 320, the method 300 includes providing a second fluid supply. In embodiments, the second fluid supply could be a liquid cleaner or cleaning solution, e.g., one typically used in connection with cleaning windshields. In block 330, the method 300 includes coupling a plurality of nozzles to the valve manifold and to the second fluid supply. The method 300 may further include directing an outlet of at least one of the nozzles at a selected one of a plurality of vehicle sensors. In embodiments, the method 300 includes locating the nozzle such that it is proximate to the selected one of the vehicle sensors. In block 340, the method 300 can further include selectively supplying the first fluid to a selected nozzle to clean the selected one of the vehicle sensors. In embodiments, the first fluid is supplied through the nozzle by selectively opening a valve associated with the nozzle to thereby clean or clear the corresponding sensor using the first fluid. In block 350, the method 300 can alternatively include selectively supplying the first fluid and the second fluid through the nozzle to clean the corresponding sensor with a combination of the first fluid and the second fluid. In embodiments, the first fluid is supplied through the nozzle by selectively opening a valve associated with the nozzle in the valve manifold, and the second fluid is supplied through a siphon induced by movement of the first fluid through the nozzle.

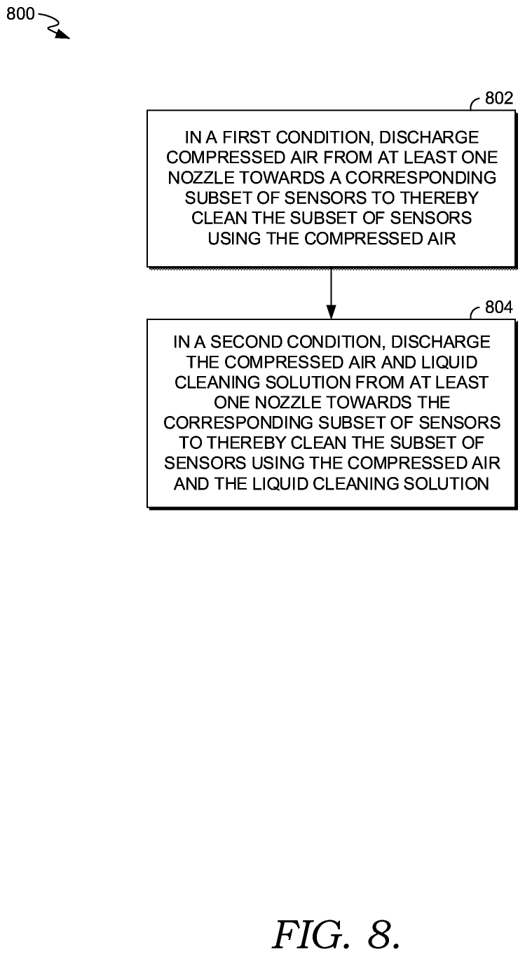

Looking now at FIG. 8, a block diagram of a method 800 for cleaning vehicle sensors, e.g., sensor(s) 179 shown in FIG. 5, is provided, in accordance with embodiments of the present disclosure. The method 800 includes blocks 802-804, but is not limited to this selection of elements or the order presented. In block 802, the method 800 includes, in a first condition, e.g., associated with a first control signal, discharging compressed air, e.g., fluid 105 in FIG. 1, from at least one nozzle, e.g., nozzles 120, 124, 128, 129,135, 138 in FIG. 1, towards a subset of sensors, e.g., sensors 102A, to thereby clean the subset of sensors using the compressed air. In block 804, the method 800 includes, in a second condition, e.g., associated with a second control signal, discharging the compressed air and a liquid cleaning solution, e.g., fluid 131 in FIG. 1, from at least one nozzle towards the corresponding subset of sensors to thereby clean the subset of sensors using the compressed air and the liquid cleaning solution. The method can include pressurizing the liquid cleaning solution in the second condition, e.g., with a compressor, or with the source of compressed air.

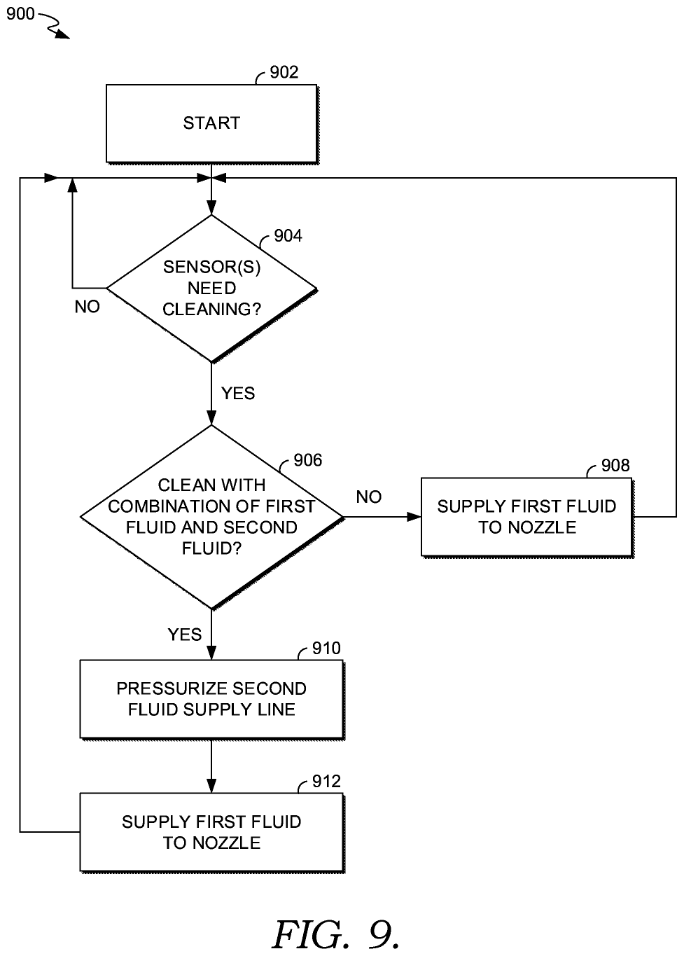

Looking now at FIG. 9, a block diagram of a method 900 for cleaning vehicle sensors, e.g., sensor(s) 179 shown in FIG. 5, is provided, in accordance with embodiments of the present disclosure. The method 900 includes blocks 902-912, but is not limited to this selection of elements or the order presented. Method 900 is described in general reference to FIGS. 1-6, and with reference to the methods described herein. Method 900 may be carried out by a controller holding executable instructions in non-transitory memory, such as controller 80A as shown at FIG. 2. In block 902, the method 900 starts, and determines, as shown at 904, whether any vehicle sensors should be cleaned. This determination can be, in embodiments, time based (such as cycling the cleaning process at certain time intervals), environmental condition based (such as dusty, rainy or other inclement weather conditions), and/or sensor-based (such as by determining that a sensor window or lens has a soiling blockage or otherwise is operating with reduced capability). If the determination at block 904 is no, then the method cycles back and continues to determine if a cleaning cycle should be initiated. If the determination at block 904 is yes, the method continues at block 906 by determining whether a cleaning cycle should be initiated with both a first fluid and a second fluid (e.g., a combination of compressed air and a liquid cleaning solution). If the determination at block 906 is “no”, the method proceeds to block 908 and includes discharging the first fluid from a nozzle or nozzles corresponding to the sensor that requires cleaning. In embodiments, at block 908, the method signals the system to discharge compressed air, e.g., fluid 105 in FIG. 1, through the valve (e.g., valve module 106) to at least one nozzle, e.g., nozzles 120, 124, 128, 129,135, 138 in FIG. 1, and towards a subset of sensors, e.g., sensors 102A, to thereby clean the subset of sensors using the compressed air. If the determination at block 906 is to initiate cleaning with a combination of the first fluid and the second fluid, the method signals the system to pressurize the second fluid outlet line (e.g., outlet line 132), as shown at block 910. Additionally, the method signals the system, at block 912, to discharge compressed air, e.g., fluid 105 in FIG. 1, through the valve (e.g., valve module 106) to at least one nozzle, e.g., nozzles 120, 124, 128, 129,135, 138 in FIG. 1. The pressure supplied to the second fluid, e.g., the second fluid 131 in line 132, along with the siphon and/or pressure drop caused by the discharge of the first fluid through the nozzle overcomes the check valve (e.g., valve 134) and discharges a combination of the compressed air and the liquid cleaning solution to a subset of sensors, e.g., sensors 102A, to thereby clean the subset of sensors using the compressed air and the liquid cleaning solution. While not explicitly illustrated, it is understood that the supplying of the first fluid to the nozzle at block 912 and block 908 includes supplying the first fluid for a specified time period, before the method cycles back to step 904 where it can be continually evaluated as to whether sensor(s) need cleaning. In some embodiments, the specified time period may be predetermined. In additional or alternative embodiments, the specified time period may be a function of one or more parameters, for example a soiling level of a sensor, time since last cleaning, weather conditions (e.g., rain, sleet, snow), road conditions (e.g., dirt, gravel, mud), traffic conditions (e.g., heavy, medium, light traffic), geographic location and/or time of year, and/or other external conditions (e.g., insect prevalence, etc.).

It should also be understood that any of the methods 300, 800, and 900 described herein could involve cleaning cycles of a hybrid-approach. For example, a cleaning cycle could be initiated with a short pulse of compressed air only (such as at block 908), followed by one or more short pulses of compressed air and cleaning solution (such as at blocks 910 and 912). In embodiments, the cleaning cycle could also conclude with a short pulse of compressed air only (such as at block 908).

In embodiments, a system for cleaning sensors is provided. In embodiments, the system can be installed on a vehicle. In embodiments, the system can be installed on a mobile platform. In embodiments, the system is installed such that the system is operable to perform a plurality of cleaning cycles on a plurality of sensors used to operate the vehicle/mobile platform, e.g., at least partially autonomously.

In embodiments, a system for cleaning sensors is provided that includes a first fluid source (e.g., compressed air or another compressed gas), a first fluid conduit, and a nozzle configured to discharge the fluid onto at least one sensor, or multiple nozzles configured to discharge the fluid onto a sensor or onto multiple sensors.

In embodiments, a system for cleaning sensors is provided. The system can include a plurality of nozzles each coupled to a first fluid source (e.g., compressed air or another compressed gas) and to a second fluid source (e.g., liquid cleaner or cleaning solution), each nozzle coupled to a corresponding first fluid conduit to the first fluid source and to a corresponding second fluid conduit to the second fluid source, and each configured to discharge one or both fluids onto at least one sensor, e.g., onto one sensor, or onto multiple sensors. In embodiments, multiple nozzles can be configured to discharge one and/or both fluids onto a single sensor, e.g., continuously or in sequences.

In embodiments, a vehicle, e.g., a freight truck, that includes a plurality of sensors, e.g., optical sensors used for operation/navigation/guidance, is provided. In an embodiment, the vehicle is autonomous, e.g., can be controlled without continuous inputs from a human operator, and/or can be directed and controlled to different locations without a human operator being locally present and providing control inputs. The vehicle includes a control system that directs operation of a plurality of nozzles coupled to a first source of fluid, and/or coupled to a first source and a second source of fluid. The control system is configured to discharge the first fluid, or discharge the first fluid and the second fluid, from the plurality of nozzles to clean the plurality of optical sensors. The cleaning may be performed in response to sensor feedback indicating degraded performance, and/or based on a schedule.

In embodiments, a sensor cleaning system uses fluid (e.g., compressed air and/or liquid cleaner) stored in multiple locations on a vehicle. For example, one or more compressors and/or tanks may provide compressed air to the sensor cleaning system; one or more fluid tanks may store liquid cleaner or cleaning solution for discharge from the sensor cleaning system. This can include tanks/containers of different volumetric storage sizes. The tanks can include larger tank(s) or container(s) and smaller tank(s) or container(s) that supply the fluid and/or that can be configured to interchange the fluid. The vehicle can include a larger tank towards or adjacent to the chassis, and can include a smaller tank, vessel, container, or another non-fluid-line storage vessel for locally distributing a liquid to nozzles of the system. Pumps and actuated valves directed by a control system may transfer fluid between the tanks, vessels, or storage locations. In addition, sensors may be used to indicate fluid levels, e.g., by sending signals locally to a controller, and/or by sending signals to a remote system, e.g., a fleet management system, among other things.

The embodiments described herein can be implemented in a variety of vehicle sizes, classes, and types (e.g., light duty trucks and other passenger vehicles, medium duty trucks, and heavy duty or commercial trucks including class 1-8 trucks, as well as other equipment and machines including buses, trams, carts, construction equipment, and the like). In addition, the subject matter of this disclosure can be used with internal combustion engine (“ICE”) vehicles, electric vehicles (“EV”), battery electric vehicles (“BEV”), hybrid electric vehicles (“HEV”), plug-in electric vehicles (“PHEV”), and with fuel-cell electric vehicles (“FCEV”), among others.
Clause 1: A system for cleaning a plurality of sensors mounted on a vehicle, the system comprising: a first fluid container configured to hold a first fluid; a second fluid container configured to hold a second fluid; a plurality of nozzles each comprising an outlet directed at a subset of the plurality of sensors, each nozzle coupled to the first fluid container via a corresponding first fluid supply line and coupled to the second fluid container via a corresponding second fluid supply line; and a controller that includes instructions stored in non-transitory memory that, when executed, cause the controller to, for at least one of the plurality of nozzles, perform the following: in a first condition, cause the first fluid to discharge from the nozzle to thereby clean the corresponding subset of sensors with the first fluid, and in a second condition, cause the first fluid and the second fluid to discharge from the nozzle to thereby clean the corresponding subset of sensors with the first fluid and the second fluid.
Clause 2: The system of clause 1, wherein the first condition is associated with a first instruction being received by the controller, and wherein the second condition is associated with a second instruction being received by the controller. air.
Clause 3: The system of any of clauses 1-2, wherein the first fluid is compressed
Clause 4: The system of any of clauses 1-3, wherein the second fluid is a liquid cleaning solution.
Clause 5: The system of any of clauses 1-4, wherein the first fluid is pressurized in the first condition and in the second condition, and wherein the second fluid is unpressurized in the first condition and pressurized in the second condition.
Clause 6: The system of any of clauses 1-5, wherein each nozzle comprises: a first inlet for introducing the first fluid into the nozzle; and a second inlet for introducing the second fluid into the nozzle; and wherein the system further comprises: a valve coupled to the second inlet; and a pump providing the second fluid to the valve, wherein the valve is configured to open in response to a siphon being produced in the nozzle by the first fluid discharging through the nozzle, thereby causing the second fluid to be introduced into the nozzle.
Clause 7: The system of any of clauses 1-6, further comprising: a valve module comprising a plurality of valves each coupled between the first fluid container and one of the plurality of nozzles, wherein each valve can be independently electronically actuated by the controller to thereby allow it to communicate the first fluid from the first fluid container to the corresponding nozzle.
Clause 8: The system of any of clauses 1-7, wherein each nozzle comprises a heating element.
Clause 9: The system of any of clauses 1-8, wherein each nozzle comprises a drain port.
Clause 10: The system of any of clauses 1-9, wherein at least one of the plurality of sensors is positioned to receive discharge from a single nozzle of the plurality of nozzles.
Clause 11: The system of any of clauses 1-10, wherein at least one of the sensors is positioned to receive discharge from multiple nozzles of the plurality of nozzles.
Clause 12: A vehicle having a system for cleaning vehicle sensors, comprising: a source of compressed air; a source of liquid cleaning solution; a valve manifold, comprising: at least one inlet coupled to the source of compressed air, and a plurality of outlets; a plurality of nozzles each coupled to one of the plurality of outlets and to the source of liquid cleaning solution, each nozzle having an outlet directed at a subset of the vehicle sensors; and a controller that includes instructions stored in non-transitory memory that, when executed, cause the controller to, for at least one of the plurality of nozzles, perform the following: in a first condition, cause the compressed air to discharge from the nozzle to thereby clean the corresponding subset of sensors with the compressed air, and in a second condition, cause the compressed air and the liquid cleaning solution to discharge from the nozzle to thereby clean the corresponding subset of sensors with the compressed air and the liquid cleaning solution.
Clause 13: The vehicle of clause 12, wherein the first condition is associated with a first instruction being received by the controller, and wherein the second condition is associated with a second instruction being received by the controller.
Clause 14: The vehicle of any of clauses 12-13, wherein, in response to receiving the second instruction, the controller pressurizes the source of liquid cleaning solution above a threshold pressure.
Clause 15: The vehicle of any of clauses 12-14, wherein the source of liquid cleaning solution is stored in a first storage container and in a second storage container that are in fluid communication with each other, and that are positioned at separate locations on the vehicle.
Clause 16: The vehicle of any of clauses 12-15, wherein the first storage container holds a first volume of the liquid cleaning solution, wherein the second storage container holds a second volume of the liquid cleaning solution, and wherein first volume is larger than the second volume.
Clause 17: The vehicle of any of clauses 12-16, wherein the second storage container is positioned closer to the plurality of nozzles than the first storage container.
Clause 18: The vehicle of any of clause 12-17, further comprising: a pump operable to transport the liquid cleaning solution from the first storage container to the second storage container; and a drain line coupled between the second storage container and the first storage container, wherein the drain line allows excess liquid cleaning solution pumped from the first storage container to the second storage container to return to the first storage container.
Clause 19: A method of cleaning sensors on a vehicle, wherein the vehicle comprises a source of compressed air, a source of liquid cleaning solution, and a plurality of nozzles each having an outlet directed at a subset of the sensors, the method comprising: in a first condition, discharging the compressed air from at least one nozzle towards the corresponding subset of sensors to thereby clean the subset of sensors using the compressed air; and in a second condition, discharging the compressed air and the liquid cleaning solution from at least one nozzle towards the corresponding subset of sensors to thereby clean the subset of sensors using the compressed air and the liquid cleaning solution.
Clause 20: The method of cleaning of clause 19, wherein the first condition is associated with a first instruction being received by a control system, and wherein the second condition is associated with a second instruction being received by the control system, and wherein, in response to the second instruction, the liquid cleaning solution is pressurized above a threshold value.

In some embodiments, this disclosure may include the language, for example, “at least one of [element A] and [element B].” This language may refer to one or more of the elements. For example, “at least one of A and B” may refer to “A,” “B,” or “A and B.” In other words, “at least one of A and B” may refer to “at least one of A and at least one of B,” or “at least either of A or B.” In some embodiments, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements. In addition, this disclosure may use the term “a” (element) or “the” (element). This language may refer to the referenced element in the singular or in the plural and is not intended to be limiting in this respect.

The subject matter of this disclosure has been described in relation to particular embodiments, which are intended in all respects to be illustrative rather than restrictive. In this sense, alternative embodiments will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

What is claimed is:

1. A system for cleaning a plurality of sensors mounted on a vehicle, the system comprising:
a first fluid container configured to hold a first fluid;
a second fluid container configured to hold a second fluid;
a plurality of nozzles each comprising an outlet directed at a subset of the plurality of sensors, each nozzle coupled to the first fluid container via a corresponding first fluid supply line and coupled to the second fluid container via a corresponding second fluid supply line; and
a controller that includes instructions stored in non-transitory memory that, when executed, cause the controller to, for at least one of the plurality of nozzles, perform the following:
in a first condition, cause the first fluid to discharge from the nozzle to thereby clean the corresponding subset of sensors with the first fluid, and
in a second condition, cause the first fluid and the second fluid to discharge from the nozzle to thereby clean the corresponding subset of sensors with the first fluid and the second fluid.

2. The system of claim 1, wherein the first condition is associated with a first instruction being received by the controller, and wherein the second condition is associated with a second instruction being received by the controller.

3. The system of claim 1, wherein the first fluid is compressed air.

4. The system of claim 1, wherein the second fluid is a liquid cleaning solution.

5. The system of claim 1, wherein the first fluid is pressurized in the first condition and in the second condition, and wherein the second fluid is unpressurized in the first condition and pressurized in the second condition.

6. The system of claim 1, wherein each nozzle comprises:
a first inlet for introducing the first fluid into the nozzle; and
a second inlet for introducing the second fluid into the nozzle; and wherein the system further comprises:
a valve coupled to the second inlet; and
a pump providing the second fluid to the valve, wherein the valve is configured to open in response to a siphon being produced in the nozzle by the first fluid discharging through the nozzle, thereby causing the second fluid to be introduced into the nozzle.

7. The system of claim 1, further comprising:
a valve module comprising a plurality of valves each coupled between the first fluid container and one of the plurality of nozzles, wherein each valve can be independently electronically actuated by the controller to thereby allow it to communicate the first fluid from the first fluid container to the corresponding nozzle.

8. The system of claim 1, wherein each nozzle comprises a heating element.

9. The system of claim 1, wherein each nozzle comprises a drain port.

10. The system of claim 1, wherein at least one of the plurality of sensors is positioned to receive discharge from a single nozzle of the plurality of nozzles.

11. The system of claim 1, wherein at least one of the sensors is positioned to receive discharge from multiple nozzles of the plurality of nozzles.

12. A vehicle having a system for cleaning vehicle sensors, comprising:
a source of compressed air;
a source of liquid cleaning solution;
a valve manifold, comprising:
at least one inlet coupled to the source of compressed air, and
a plurality of outlets;
a plurality of nozzles each coupled to one of the plurality of outlets and to the source of liquid cleaning solution, each nozzle having an outlet directed at a subset of the vehicle sensors; and
a controller that includes instructions stored in non-transitory memory that, when executed, cause the controller to, for at least one of the plurality of nozzles, perform the following:
in a first condition, cause the compressed air to discharge from the nozzle to thereby clean the corresponding subset of sensors with the compressed air, and
in a second condition, cause the compressed air and the liquid cleaning solution to discharge from the nozzle to thereby clean the corresponding subset of sensors with the compressed air and the liquid cleaning solution.

13. The vehicle of claim 12, wherein the first condition is associated with a first instruction being received by the controller, and wherein the second condition is associated with a second instruction being received by the controller.

14. The vehicle of claim 13, wherein, in response to receiving the second instruction, the controller pressurizes the source of liquid cleaning solution above a threshold pressure.

15. The vehicle of claim 12, wherein the source of liquid cleaning solution is stored in a first storage container and in a second storage container that are in fluid communication with each other, and that are positioned at separate locations on the vehicle.

16. The vehicle of claim 15, wherein the first storage container holds a first volume of the liquid cleaning solution, wherein the second storage container holds a second volume of the liquid cleaning solution, and wherein first volume is larger than the second volume.

17. The vehicle of claim 16, wherein the second storage container is positioned closer to the plurality of nozzles than the first storage container.

18. The vehicle of claim 15, further comprising:
a pump operable to transport the liquid cleaning solution from the first storage container to the second storage container; and
a drain line coupled between the second storage container and the first storage container, wherein the drain line allows excess liquid cleaning solution pumped from the first storage container to the second storage container to return to the first storage container.

19. A method of cleaning sensors on a vehicle, wherein the vehicle comprises a source of compressed air, a source of liquid cleaning solution, and a plurality of nozzles each having an outlet directed at a subset of the sensors, the method comprising:
in a first condition, discharging the compressed air from at least one nozzle towards the corresponding subset of sensors to thereby clean the subset of sensors using the compressed air; and
in a second condition, discharging the compressed air and the liquid cleaning solution from at least one nozzle towards the corresponding subset of sensors to thereby clean the subset of sensors using the compressed air and the liquid cleaning solution.

20. The method of claim 19, wherein the first condition is associated with a first instruction being received by a control system, and wherein the second condition is associated with a second instruction being received by the control system, and wherein, in response to the second instruction, the liquid cleaning solution is pressurized above a threshold value.
